(19) United States
(12) Patent Application Publication
(10) Pub. No.: US 2016/0053538 A1
(43) Pub. Date: Feb. 25, 2016

(54) PLATFORM UNIT FOR USE WITH SCAFFOLDING STRUCTURE

(71) Applicant: PLUSEIGHT TECHNOLOGY AB, Hindås (SE)

(72) Inventor: Harry Wallther, Hindas (SE)

(21) Appl. No.: 14/888,675

(22) PCT Filed: Dec. 30, 2013
(86) PCT No.: PCT/EP2013/078142

§ 371 Date: Nov. 2, 2015

(30) Foreign Application Priority Data
May 2, 2013 (SE) 1350541-7

(51) Int. Cl. E06C 1/393; E06C 1/397; E04G 1/30; E04G 1/24; E04G 5/10; E04G 5/00

(52) U.S. Cl. CPC E06C 1/393; E04G 5/10; E04G 5/001; E04G 1/30; E04G 1/24; E06C 1/397; E04G 2001/242; E04G 2001/307

(57) ABSTRACT

A platform unit used with a scaffolding structure includes a worker's platform and a ladder for climbing onto the worker's platform. The platform unit includes a first tipping prevention member adapted to interact with a substantially horizontal longitudinally extending first support member, and a second tipping prevention member adapted to interact from below with a substantially horizontal longitudinally extending second support member. The second support member is vertically spaced apart from the first support member. At least a part of at least one of the first and second tipping prevention members is vertically adjustable for enabling attachment and detachment of the platform unit to the scaffolding structure. At least three rollers support the platform unit, with each of the rollers adapted to rest against either the first support member or the second support member, such that the platform unit is rollingly movable in the longitudinal direction.

### TECHNICAL FIELD

This invention relates to a platform unit for use with a scaffolding structure. The invention also relates to a scaffolding structure comprising such a platform unit, as well as a method for attaching a platform unit to a scaffolding structure. The invention is particularly advantageous in the field of secure assembly or disassembly of a scaffolding structure.

### BACKGROUND OF THE INVENTION

Fall from a height remain one of the main causes of fatal work accident, especially in the construction industry. Scaffolding structures usually have guardrails around platform levels in order to prevent people, typically workers, from falling down. Once installed, the guardrails usually provide an efficient protection means. However, alternative protection devices are often required for workers involved in assembling, altering or disassembling the scaffold, when guardrails are missing.

The alternative protection device that has traditionally been available for these workers is a harness tethered to already constructed parts of the scaffold. However, a harness serves to arrest a fall, not to prevent it, and there is still a risk of the worker getting seriously injured in the fall. A European Directive on work at a height stipulates that prevention measures should be adopted before mitigation measures.

Systems that seek to prevent falls from scaffolds rather than to mitigate their effects have been developed. One example is advanced guardrails that are installable from a secure position on a lower level, as for example shown in WO2004029382. Another example is a worker's platform which is hooked onto the guardrails of the lower level, as described in GB2459181B. By standing on the platform, a worker can reach high enough as to mount the guardrails of the above level of the scaffold, without having to enter that level. However, handling of the platform is time-consuming and there is nearly always a stability risk when climbing a ladder or elevated platform.

There is thus a need for an improved protection device removing at least partly the above mentioned disadvantages.

### SUMMARY OF THE INVENTION

An object of the present invention is to provide a platform unit that can be safely and relatively easily temporarily attached to the scaffolding structure while allowing a rolling displacement of the platform unit along the longitudinal length of the scaffolding structure. This object is achieved by the features of the independent claims.

The invention concerns a platform unit for use with a scaffolding structure, the platform unit comprising a worker's platform and a ladder for climbing onto the worker's platform.

The invention is characterised in that the platform unit further comprises a first tipping prevention member which is adapted to interact with a substantially horizontal longitudinally extending support member of the scaffolding structure, a second tipping prevention member which is adapted to interact from below with a substantially horizontal longitudinally extending second support member, which second support member is vertically spaced apart from the first support member, wherein at least a part of at least one of the first and second tipping prevention members is vertically adjustable for enabling attachment and detachment of the platform unit to said scaffolding structure, and at least three rollers for supporting the platform unit, wherein each of the rollers is adapted to rest against either said first support member or said second support member of the scaffolding structure, such that the platform unit is rollingly movable in the longitudinal direction.

The advantage of the inventive solution is that the longitudinal position of the platform unit may be easily changed when the platform unit is still attached to the scaffolding structure, also when carrying a load, typically a worker standing on the worker's platform. Assembly or disassembly of for example a guard rail on the scaffold level located above the scaffold level of the platform unit, first at one end of the rail and subsequently at the other end of the rail, is thus simplified due to the simplified longitudinal displacement. The platform unit may even allow the worker to hold on to the guardrail to be mounted/dismounted during the complete assembly or disassembly step. For example, the worker may begin with attaching one end of a guardrail of the above scaffold level, then manually bringing the platform unit in motion in the longitudinal direction in order to roll the platform unit to the position where the other end of the guardrail can be mounted/dismounted. The previous solution required an intermediate step of disconnecting of the platform unit from the scaffolding structure, carrying the platform unit to a new position and subsequent attachment of the platform unit to the scaffolding structure. Moreover, due to the required manual handling of the platform it was necessary for the worker to set the semi-assembled/disassembled rail aside as a further intermediate step, thereby further increasing the level of manual handling and risk that the scaffolding members, such as a guardrail, uncontrolled falls down.

Another advantage of the inventive solution is that the platform unit is quickly and easily attachable and detachable to the scaffolding structure. The platform is preferably repositioned more or less laterally to the longitudinally extending first and second support members and then at least one tipping prevention member is vertically adjusted in order to attach the platform unit to the scaffolding structure. A certain level of vertical repositioning of the platform unit may be required in connected with attachment/disattachment of the platform unit to the scaffolding structure due to the form and shape of stationary tipping prevention member parts. To detach the platform unit, the process is reversed. No adjustments or movements in the longitudinal direction are required.

Further advantages are achieved by implementing one or several of the features of the dependent claims.

According to an aspect of the invention, the substantially horizontal longitudinally extending first support member is a first rail, such as a guard rail, or a working deck.

According to a further aspect of the invention, the substantially horizontal longitudinally extending second support member is a second rail, such as a guard rail.

If both the first and second tipping prevention members are vertically adjustable, then they may be vertically adjustable independently of each other, i.e. they can be vertically adjusted relative to each other. Alternatively, only one of the first and second tipping prevention members is vertically adjustable while the other of the first and second tipping prevention members is vertically non-adjustable, i.e. stationary.

The first and second tipping prevention members are jointly arranged to enable prevention of the platform unit from tipping forward at least in the lateral direction, preferably also sideways in the longitudinal direction. This means that the first and second tipping prevention members alone cannot prevent forward tipping of the platform unit, but the combination of the first and second tipping prevention members when cooperating can prevent forward tipping.

The platform unit may be a free-standing unit, wherein each of said at least three rollers is adapted to rest against the working deck and to transfer any vertical load acting on the worker's platform to the working deck when the platform unit is in a normal position, and wherein the first and second tipping prevention members are arranged to guide the platform unit along the first and second support members. By transferring the vertical load to the working deck of the scaffolding structure improves safety because the working deck is designed to carry a substantial vertical load. Transferring the vertical load to the guard rails or similar structure is generally less safe. Furthermore, designing the first and second tipping prevention members for guiding the platform unit in the longitudinal direction along the first and second support members enables a controlled and safe rolling motion of the platform unit when moving in the longitudinal direction. As used herein, “normal position” refers to an upright, balanced position of the platform unit, i.e. the platform unit is not tilting in any direction and all rollers are in contact with the respective rail or working deck that they are adapted to rest against.

Preferably, the platform unit comprises four or more rollers that are adapted to rest against the working deck. Four rollers at four different locations, preferably at or near the lower corners of the platform unit, result in a very stable free-standing platform unit.

Alternatively, at least one of said rollers is provided at the first tipping prevention member, and the roller is arranged to transfer a load to the first support member when the platform unit is in an attached position. This design enables a more compact and light-weight platform unit because the platform unit may exhibit for example only two rollers contacting the working deck, and at least one roller contacting and transferring load to the first support member. As used herein, “attached position” refers to position where the platform unit is an attached state, i.e. being attached to the scaffolding structure by means of the first and second tipping prevention members. In the attached position, the platform unit is prevented from tipping while still being able to move in the longitudinal direction.

At least one of said rollers may be provided at or adjacent to the bottom end of the ladder and arranged to rest on the working deck. Thereby a load on the platform unit may be transferred to the working deck via the ladder. In such case, the ladder may exhibit multiple functionalities by serving as climbing means for the worker and as support for the worker's platform, all whilst additionally enabling platform unit mobility in the longitudinal direction.

The platform unit may comprise a pair of legs extending generally vertically downwards from a front end of the worker's platform. A load of the platform unit may thus be transferred to the working deck via the pair of legs. The legs are preferably oriented substantially vertical but may exhibit a certain inclination, such as for example +/−20 degrees over the length of the legs. It may be desirable to locate the worker's platform close to the outer edge of the scaffolding structure, i.e. close to the second support member for simplifying securement to the second support member and avoiding lengthy tipping prevention members between the platform unit and the second support member. A substantially vertical orientation of the legs may thus be advantageous. The pair of legs may extend generally vertically downwards from a front end of the worker's platform, and at least one of said rollers may be provided at or adjacent to the bottom end of each leg, which rollers are adapted to contact the working deck.

The first tipping prevention may be constituted by at least one stopping member extending downwards and arranged to interact with a side surface of the working deck or scaffolding structure for preventing the platform unit from tipping forwards. This is an alternative design suitable when for example there is only one guard rail available as support member. Without the stopping member in engaged position, forward leaning of a user positioned on the worker's platform may generate a forward torque around the first support member, which torque is only opposed by the coupling between the tipping prevention member and the first support member and the weight of the platform multiplied with the transverse offset of the centre of mass of platform unit from the planned position of the second support member.

The legs of the platform unit may also extend upwards from the worker's platform. This is advantageous since the upper parts of the legs may be used for fastening a fall prevention barrier. They can also be gripped by a user standing on the worker's platform for improved balance.

A leg part of at least one leg may constitute the first tipping prevention member. This is advantageous since it requires no additional parts for manufacturing the first tipping prevention member than already provided by the at least one leg. Also, there is no need for attaching the first tipping preventation member to the first support member. Mere abutment against the first support member will occur in case the platform unit starts tilting forward. Since it is sufficient to merely place the first tipping prevention member adjacent the first support member mounting and dismounting of the platform unit is simplified.

The second tipping prevention member may comprise at least one roller which is arranged to transfer a load to the second support member when the platform unit is in the attached position, and the platform unit may be free from any contact to the working deck. This design is particularly advantageous when the working deck does not exhibit a smooth and even upper surface that is suitable for supporting rollers. Moreover, the platform unit may have a compact and light-weight design.

The first tipping prevention member may be hook-shaped and exhibit a cavity open from below, which cavity is arranged to receive the first support member, such that the first tipping prevention member can transmit a vertical and/or horizontal force to the first support member. An open cavity enables a quick and effective engagement of the first tipping prevention member with the first support member, i.e. merely by moving the first tipping prevention member substantially vertically downwards from a position above the first support member. No further actions related to the first tipping prevention member are needed for engagement with the first support member. The first tipping prevention member may be fixedly coupled to the platform unit, or form an integral part thereof.

The first and/or second tipping prevention member may be configured to provide an air gap between the tipping prevention member and the associated support member in the attached position in certain designs of the platform unit in an effort to reduce friction between the platform unit and scaffolding structure during longitudinal sliding along the support member, in particular if the platform unit is a free-standing object. The air-gap may for example be provided in the vertical direction, such that the tipping prevention member is separated by a certain distance from the associated support member. The air-gap is provided between the tipping prevention member and associated rail when the platform unit is in the attached position. The distance is preferably not too large since the tipping prevention members can then no longer significantly contribute to the longitudinal tipping prevention of the platform unit. Only when the vertical distance between at least one of the tipping prevention member and the support member is sufficiently small, typically less than 50 millimetres, can the tipping prevention member after only a small degree of platform unit tipping come into contact with the support member and thereby preventing any further tipping in that direction.

The second tipping prevention member may be hook-shaped and exhibit a cavity open from above, which cavity is arranged to receive the second support member, such that the second tipping prevention member can transmit a vertical and/or horizontal force to the second support member. See advantageous above with respect to the hook-shaped first tipping prevention member, which advantages apply also to the second tipping prevention member.

The first and/or second tipping prevention member may comprise at least one substantially vertically oriented roller, which is arranged to transfer at least a horizontal force to the first or second support member. A substantially vertically oriented roller is characterised in that it exhibits a substantially vertical axis of rotation. Such a roller reduces contact friction between the platform unit and the first or second support member in case a contact occurs; thereby further simplifying handling and sliding motion of the platform unit during longitudinal repositioning in the attached state.

The first and/or second tipping prevention member may comprise at least one substantially horizontally oriented roller, which is arranged to transfer at least a horizontal force to the first or second support member. A substantially horizontally oriented roller is characterised in that is exhibits a substantially horizontal axis of rotation. Such a roller reduces contact friction between the platform unit and first or second rail in case a contact occurs; thereby further simplifying handling and sliding motion of the platform unit during longitudinal repositioning in the attached state.

The substantially horizontally oriented roller may exhibit a peripheral groove that is arranged to interact with the first or second support member, such that the roller may transfer both vertical and horizontal forces to the first or second support member. Such a roller is primarily suitable for platform designs where at least one of the tipping prevention members is in contact with the first or second support member during normal use of the platform unit and has the advantage of providing both vertical and horizontal support using a single roller, thereby saving costs and reducing platform unit design complexity.

At least one of the first and second tipping prevention members may comprise a rotatable locking element that may be manually rotated for adjusting the vertical position of the locking element. This solution provides easy engagement and disengagement of the first and/or second tipping prevention member to the corresponding support member, as movement of the locking element is substantially the only action required, possibly followed by a securing action for securing that the locking element cannot accidentally reposition to an unlocked position. This design provides a robust, safe and non-complex construction.

The rotatable locking element may be manually rotated by turning a operating member, such as a handle or knob. The operating member may for example be connected to the locking element by a shaft that is located in a hole on the rigid frame of the platform unit. The rigid frame may for example be a substantially horizontally extending base member that is arranged to be located below the second support member in the attached position. The rotatable locking element would then be attached to the base member.

As an alternative design, at least one of the first and second tipping prevention members may be vertically slidable along at least one leg for adjusting the vertical position of the locking element.

In certain embodiments, only one of the first and second tipping prevention members is vertically adjustable while the other tipping prevention member is stationary. This design enables a more cost-effective solution and less handling by the user.

The platform unit may comprise two first tipping prevention members spaced apart in the longitudinal direction. This arrangement enables improved prevention of the platform unit from tipping in the longitudinal direction. A more spread out interaction between the platform unit and the first support member in the longitudinal direction improves stability of the platform unit and reduces the contact force applied to first tipping prevention members when they prevent the platform unit from tipping in the longitudinal direction. The platform unit may comprise two second tipping prevention members spaced apart in the longitudinal direction for the same reason.

The platform unit may comprise a fall prevention barrier that is arranged to prevent a user positioned on the worker's platform from falling off the platform unit. The fall prevention barrier may surround at least three sides of the worker's platform. The fall prevention barrier increases the safety for a person standing on the worker's platform since it prevents him/her from falling in a direction out from the scaffold, possibly all the way down to the ground. The side of the worker's platform to which the ladder attaches may be left without fall prevention barrier in order to facilitate climbing onto the platform. This side usually faces the facade or similar along which the scaffolding structure is erected, and a fall in this direction would be stopped quite immediately by the working deck of the scaffolding structure or by said facade or similar. Alternatively, the fall prevention barrier may surround all four sides of the worker's platform for further improved safety. The surrounding fall preventation barrier is then preferably non-openable to prevent unintentional opening and the worker must enter the surrounding barrier from below upon climbing the ladder. Alternatively, the ladder may comprise two side bars interconnected by at least one rung, and the ladder side bars extend upwardly from the worker's platform and form part of the fall prevention barrier. Thereby the side bars of the ladder exhibit multiple functionalities and as such results in a more compact and light-weight design. The fall prevention barrier may be mounted to an upper part of the side bars. Still more alternatively, the legs may extend upwardly from the worker's platform and form part of the fall prevention barrier. Thereby the legs of the platform unit exhibit multiple functionalities and as such results in a more compact and light-weight design. Still more alternatively, the fall prevention barrier may be mounted to an upper part of the legs.

The platform unit may comprise at least one scaffolding material holder. For example, guard rails to be mounted to the scaffolding structure may be held by the material holder. This enables the user of the platform unit to carry material with him on the platform unit upon motion in the longitudinal direction without occupying his hands for holding the material.

The platform unit may comprise at least one end stop surface adapted to stop a longitudinal motion of the platform unit upon encounter with a vertical post of the scaffolding structure. This increases the safety and comfort of the user of the platform unit as the platform unit is stopped in a controlled manner when it reaches a the end of the current scaffolding segment.

The platform unit may be foldable into a substantially parallel folded configuration when the platform unit is not in use. In the folded configuration it becomes less bulky and hence more convenient to carry, transport, and store.

The ladder may be pivotally attached to the legs for enabling folding of the platform unit.

The worker's platform may be pivotally attached to the legs for enabling folding of the platform unit.

The fall prevention barrier may be pivotally attached to the legs for enabling folding of the platform unit.

The substantially horizontal longitudinally extending first support member may be formed by a first rail or a working deck. Using a first rail, such as an existing guard rails of the scaffolding structure as first support member enables an efficient additional use of the guard rail. The scaffolding structure is mostly provided with one or more guard rails that are horizontally arranged and located vertically spaced apart. The guard rails serve to prevent a worker located on the scaffolding structure from accidentally falling down. Similar advantage applies when using the working deck as first support member.

The substantially horizontal longitudinally extending second support member may be formed by a second rail. This is also an cost-effective solution for the same reasons as just described above.

The invention also concerns a scaffolding structure comprising a substantially horizontal longitudinally extending first support member, wherein the scaffolding structure further comprising a platform unit as described above that is secured to the scaffolding structure by means of the first and second tipping prevention members.

The invention also concerns a method for attaching a platform unit as described above to a scaffolding structure. The method may comprise the steps of positioning the platform unit such that the first and second tipping prevention members are located close to the first and second support members respectively, and subsequently adjusting at least a part of at least one of the first and second tipping prevention members in a vertical direction, such that the platform unit becomes attached to the scaffolding structure. This method of attaching the platform unit is straight forward, fast, relatively self-explanatory, and correct securement to the scaffolding structure is easy to verify, thereby providing a safe use of the platform unit.

As used herein, the term “longitudinal direction” is defined as a direction along the length of the first and second support members. Furthermore, as used herein, “interact from below” means interacting with an exterior lower surface of the support member, i.e. with the outer bottom surface of the support member. Interaction from within, such as when a member is located within a support member, is not included in “interact from below” as used herein.

### BRIEF DESCRIPTION OF DRAWINGS

In the detailed description of the invention given below reference is made to the following figures, in which:

FIG. 1 shows a first embodiment of the platform unit viewed from the rear (a), side (b) and top (c),

FIG. 2 shows a second embodiment of the platform unit viewed from the rear (a), side (b) and top (c),

FIG. 3 shows the platform unit of FIG. 2 secured to a scaffolding structure,

FIG. 4 shows a third embodiment of the platform unit secured to a scaffolding structure,

FIG. 5 shows a fourth embodiment of the platform unit secured to a scaffolding structure,

FIG. 6 shows a fifth embodiment of the platform unit secured to a scaffolding structure, and

FIG. 7 shows a sixth embodiment of the platform unit, in an unfolded state (a) as well as in a folded state (b).

### DETAILED DESCRIPTION

Various aspects of the invention will hereinafter be described in conjunction with the appended drawings to illustrate but not to limit the invention, wherein like designations denote like elements. Variations of the inventive aspects are not restricted to the specifically shown embodiments, but are applicable on other variations of the invention.

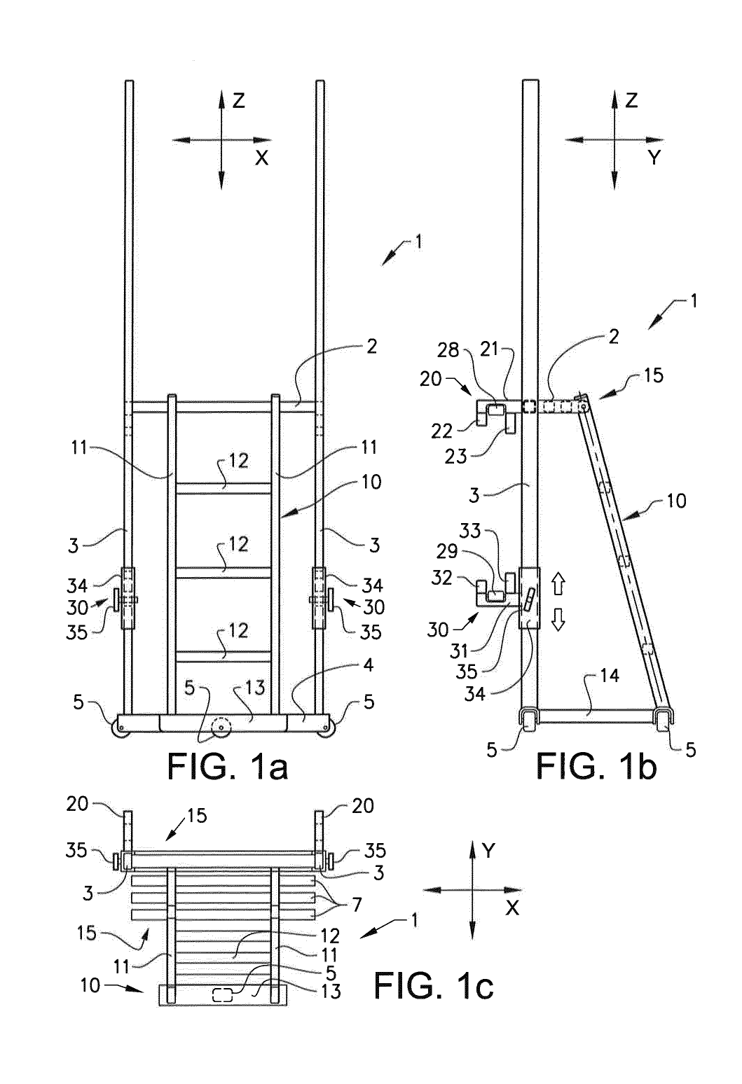

FIGS. 1a-1c shows the inventive platform unit 1 according to a first embodiment in three different views: rear view (FIG. 1a), side view (FIG. 1b) and top view (FIG. 1c). The platform unit 1 comprises a horizontal worker's platform 2 adapted for a worker to stand on when performing work at an elevated height, for example assembling guardrails belonging to the above scaffold level. When assembling a scaffolding structure, one approach is to install the working deck for the next level while still standing on the lower level. Thereafter the worker climbs to the new upper level and installs the guardrail before starting assembly of the next level of the scaffolding structure. Climbing onto a new level before the guardrails are installed is however always associated with a certain risk for falling down. The present invention aims at removing this risk by enabling installation of the guardrails for the next level as a first step, and thereafter installing the working deck for the next level. As a result, when the worker climbs up the scaffolding structure to the new level the guardrails are already installed and the risk for falling down is reduced. The same applies during disassembly of a scaffolding structure.

The worker's platform 2 is supported at its front end 16 by a pair of legs 3, which are connected by a first horizontal member 4 at their lower ends in order to increase the stability of the structure. The first horizontal member 4 is provided with one roller 5 at each end. The axis of rotation of each roller 5 is oriented horizontally and perpendicular to the longest dimension of the first horizontal member 4. The legs 3 also extends upwards from the front edge 16 of the worker's platform 2 and form gripping means for a worker using the platform unit 1, as well as a certain level of fall prevention barrier.

At its rear end 15, the worker's platform 2 is supported by a ladder 10. The ladder 10 comprises side bars 11, horizontal rungs 12, and a second horizontal member 13 connecting the side bars 11 at their lower ends. The ladder 10 may alternatively comprise steps instead of rungs 12. The second horizontal member 13 is provided with a roller 5 placed approximately at the centre of the second horizontal member 13. The purpose of the platform unit 1 being provided with rollers 5 is to allow the platform unit 1 to easily move sideways, i.e. in a longitudinal direction X, also when the platform unit 1 carries a load, such as a worker. Two reinforcing members 14 extending in a lateral direction Y, perpendicular to the longitudinal direction X, connect the first and second horizontal members 4, 13 for the sake of stability.

The front end 16 of the worker's platform 2 is further provided with two first tipping prevention members 20. Each first tipping prevention member 20 comprises a first horizontal part 21, a first vertical part 22, and a second vertical part 23. The first tipping prevention members 20 are adapted to be arranged relative to a first support member of the scaffolding structure. The first support member is in this embodiment constituted by a first horizontal guard rail of a scaffolding structure. Upon proper attachment of the first tipping preventation member 20 to the first rail the first rail will be contained between the first and second vertical parts 22, 23, and below the first horizontal part 21.

Two second tipping prevention members 30 are provided below the worker's platform 2, one on each leg 3. Each second tipping prevention member 30 comprises a second horizontal part 31, a third vertical part 32, and a fourth vertical part 33. The second tipping prevention members 30 are adapted to be arranged relative to a second support member of the scaffold. The second support member is in this embodiment constituted by a second horizontal guard rail of a scaffolding structure. Upon proper attachment of the second tipping preventation member 30 to the second rail the second rail will be contained between the third and fourth vertical parts 32, 33, and above the second horizontal part 31. The second tipping prevention members 30 further comprise a collar 34 that is sliding connected to the leg 3 in a vertical direction Z, said collar 34 being provided with a threaded member 35, for example a wing bolt, that fixes the vertical position of the second tipping prevention member 30 relative to the leg 3. Untightening the threaded member 35 releases the collar 34 from the leg 3 and the vertical position of the second tipping prevention member 30 can be adjusted by sliding the collar 34 up and down in the vertical direction. Tightening the threaded member 35 fixes the second tipping prevention member 30 in the new vertical position. The threaded member 35 could be replaced by for example a cam clamping mechanism, a wedge clamping mechanism, a pin and hole fastening mechanism, or similar fastening mechanisms. The two second tipping prevention members 30 may preferably be located on a common adjusting mechanism, such that both second securing mechanisms 30 are vertically adjusted by a common adjustment member and a common fastening mechanism for the purpose of simplifying handling of the platform unit 1.

The vertical adjustability of the second tipping prevention member 30 allows the platform unit 1 to be easily attached and detached from two rails of the scaffolding structure. Before the platform unit 1 is to be secured to the horizontal rails, the second tipping prevention members 30 are lowered such that the distance between the first and second tipping prevention members 20, 30 is significantly greater than the distance between the first and second horizontal rails. In this state, the platform unit 1 can be slightly lifted and easily controlled to position the first tipping prevention members 20 around the first horizontal rail from above, without the motion being hindered by the third and fourth vertical parts 32, 33 of the second tipping prevention members 30 bumping into the second horizontal rail. The second tipping prevention members 30 are instead positioned well below the second horizontal rail. With the first tipping prevention members 20 in place, the second tipping prevention members 30 are raised to a position in which the third and fourth vertical parts 32, 33 surround the second horizontal rail from below. The procedure is simply reversed when the platform unit 1 is to be unsecured from the horizontal rails.

When secured to a horizontal rail, the first and second tipping prevention members 20, 30 are advantageously arranged such that a small distance, for example about 5-50 millimetres, preferably 10-40 millimetres, separates their horizontal part 21, 31 from the respective horizontal rail, such that frictional drag losses are at least partly avoided when the platform unit 1 moves sideways, in a longitudinal direction X. This corresponds to an attached position of the design of the platform unit, i.e. a position where the platform is temporarily attached to the scaffolding structure, not tilting in any direction and all rollers 5 are in contact with the surface of the working deck. Similarly, also the first and second vertical parts 22, 23 and third and fourth vertical parts 32, 33 are preferably located to exhibit a horizontal gap therebetween that is larger than a maximal dimension of the rail in a lateral direction Y, such that a certain play exists between the rail and the neighbouring first and second vertical parts 22, 23 and third and fourth vertical parts 32, 33 respectively in a normal position. During sideways motion of the platform unit in the normal position the first, second, third and fourth vertical parts 22, 23, 32, 33 serve to steer and control the position of the platform unit to maintain a substantially constant distance to the first and second horizontal rails of the scaffolding structure, as well as preventing the platform unit from tilting forwards or rearwards in the lateral direction Y. Forward tilting is tilting counter-clockwise in FIG. 1b.

If the secured platform unit 1 for some reason starts to tilt rearwards in the lateral direction Y relative to the horizontal rails the first vertical part 22 of the first tipping prevention members 20 may abut against the first rail and the horizontal part 31 of the second tipping prevention member 30 will engage the lower exterior surface of the second rail, thus preventing the platform unit 1 from tipping rearward in the lateral direction Y. Similarly, if the secured platform unit 1 for some reason starts to tilt forward in the lateral direction Y relative to the horizontal rails, the second vertical part 23 of the first tipping prevention member 20 will abut against the first rail and the third vertical part 32 of the second tipping prevention members 30 will abut against the second rail, thus preventing the platform unit 1 from tipping in forwards in the lateral direction Y.

If the secured platform unit 1 for some reason starts to tilt in the longitudinal direction X along the horizontal rails, the horizontal parts 21, 31 of the first and second tipping prevention members 20, 30 will soon abut against the horizontal rails, thus preventing the platform unit 1 from tipping in the longitudinal direction. In the disclosed platform unit of FIG. 1a-1c there are two first tipping prevention members 20 positioned spaced apart in the longitudinal direction, and two second tipping prevention members 30 positioned spaced apart in the longitudinal direction. However, many alternative designs are possible, having for example a single first and second tipping prevention member 20, 30, which exhibit a relatively large longitudinal extension, for the purpose of providing a sufficiently strong protection against tipping in the longitudinal direction X.

The air gap between the tipping prevention member and the first and second rail, both in the vertical and lateral direction Z, Y, define the extent of tipping before the further tipping is prevented, i.e. the maximal tipping angle that is possible. A small air gap obviously results in a small maximal tipping angle but may increase the friction between the platform and rails.

Each of the first, second, third and fourth vertical parts 22, 23, 32, 33 may comprise a vertically oriented roller for reducing contact friction with the associated horizontal rail during sideways motion of the platform unit. Likewise, each of the horizontal parts 21, 31 of the first and second tipping prevention members 20, 30 may comprise a horizontally oriented roller 28, 29 for the same purpose. Alternatively, one or more of the vertical or horizontal part 22, 23, 32, 33, 21, 31 may have a sliding surface that is arranged to slide against the associated horizontal rail during certain use conditions, whereby the sliding surface may exhibit a low-friction coating, liner, or similar part for reducing the sliding contact friction. A combination of rollers and sliding surfaces is also possible.

The platform unit is preferably manufactured mainly by any suitable aluminium alloy or steel material for exhibiting sufficient robustness and sturdiness to enable long and safe use of the platform unit. Certain less critical parts of the platform unit may possibly be manufactured in plastic material for reduced weight and cost of the platform unit.

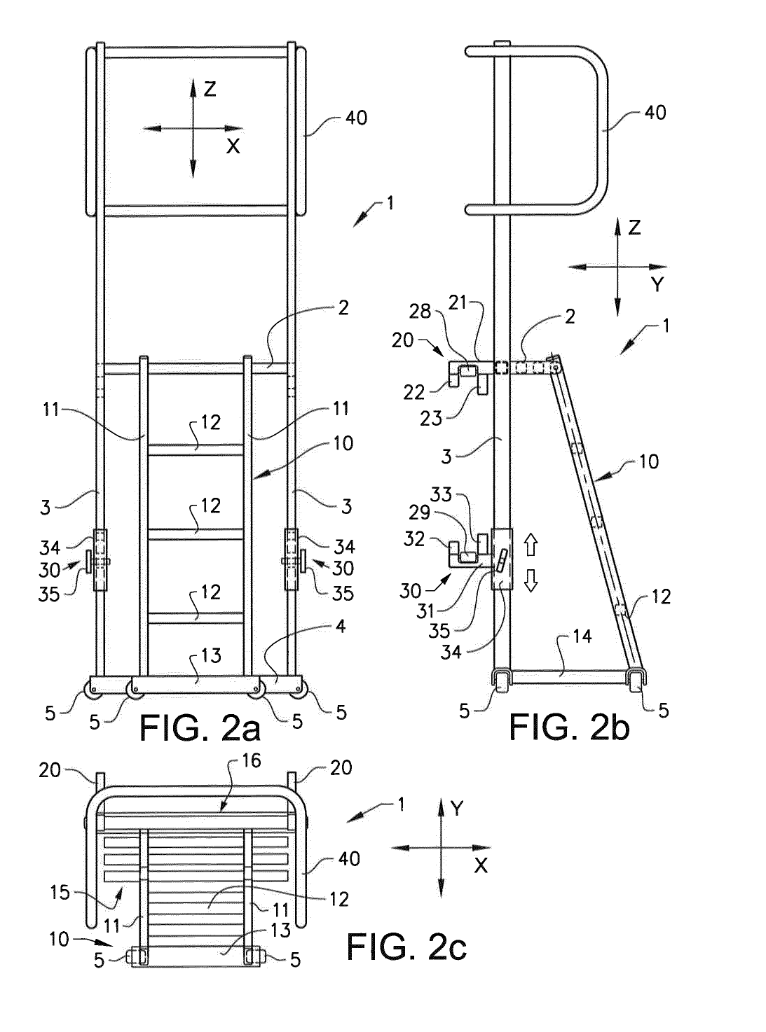

FIG. 2 shows a second embodiment of the inventive platform unit 1 from three different views: rear view (FIG. 2a), side view (FIG. 2b) and top view (FIG. 2c). This alternative design resembles the first design shown in FIG. 1a-c, but here the second horizontal member 13 at the bottom of the ladder 10 is provided with two rollers 5, one at each end, for improved stability. A fall prevention barrier 40 is attached to the upper parts of the legs 3. The fall prevention barrier 40 is U-shaped at two vertical levels and arranged such that it surrounds three sides of a person standing on the worker's platform 2. The purpose of the fall prevention barrier 40 is to prevent a person standing on the worker's platform 2 from falling from the platform unit 1, and possibly also from the scaffold. In this example, the fall prevention barrier 40 does not protect a person standing on the worker's platform from falling rearwards in the direction of the ladder 10. However, in that direction, a fall would be stopped quite immediately by the working deck of the scaffolding structure, on which the ladder 10 rests, and the facade or similar along which the scaffolding structure is erected. The fall prevention barrier 40 may alternatively be arranged such that it surrounds all four sides of a person standing on the worker's platform 2. The part of the fall prevention barrier facing rearwards, i.e. towards the person climbing the platform, may be fixed or moveable. A fixed solution enables a stronger and more reliable fall prevention barrier but may be detrimental in terms of user-friendliness since a user may have difficulties entering the worker's platform. A moveable solution, for example by means of an openable gate, enables improved user-friendliness but suffer from reduced safety since the lock of the gate form a weakness in terms of strength and incorrect user handling.

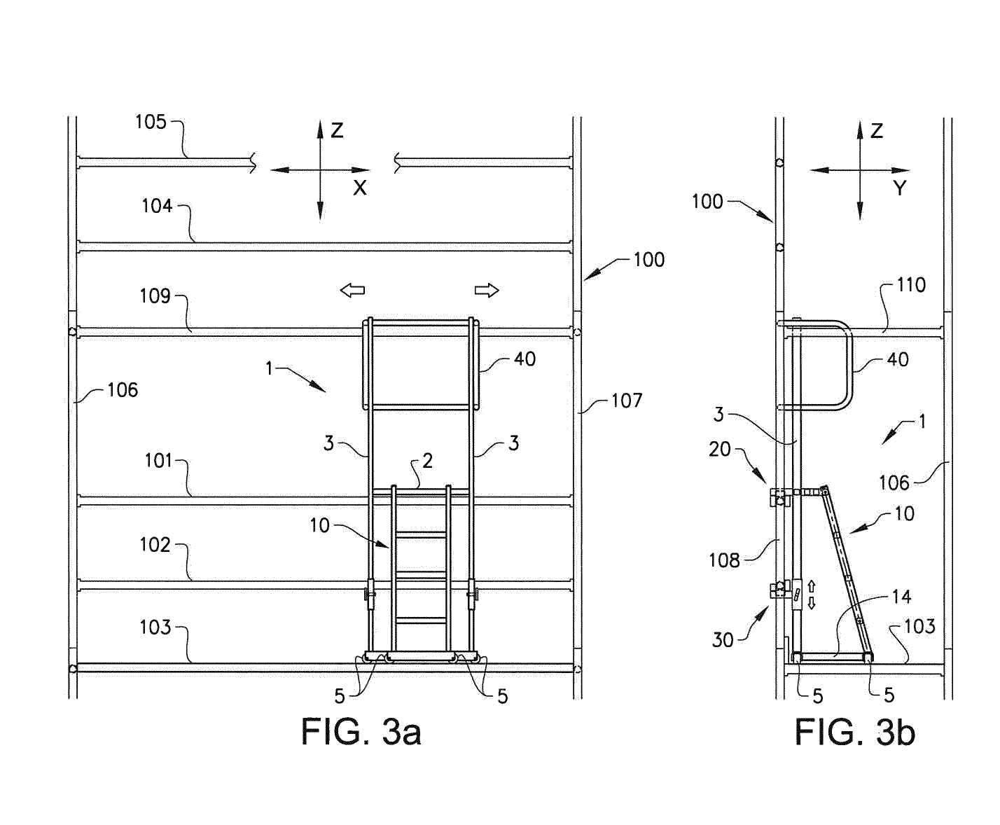

FIG. 3 shows the alternative design of the platform unit 1 of FIG. 2a-2c secured to a scaffolding structure 100 from two different views: rear view (FIG. 3a) and side view (FIG. 3b). The rollers 5 of the platform unit 1 rests on the working deck 103. Two first tipping prevention members 20 secures the platform unit 1 to a first support member 101. The first support member 101 is in this embodiment constituted by a first horizontal guard rail 101 of a scaffolding structure. Two adjustable second tipping prevention members 30 secures the platform unit 1 to a second support member 102. The second support member 102 is in this embodiment constituted by a second horizontal guard rail 102 of a scaffolding structure. The second horizontal guard rail 102 is situated vertically below the first horizontal rail 101. The first and second horizontal rails 101, 102 are the existing guardrails of the scaffolding structure 100 level in which the working deck 103 serves as a floor for construction workers. While standing on the worker's platform 2, a worker can easily reach to mount the guardrails 104, 105 of the above level of the scaffolding structure 100 while being protected from severe falling by the fall prevention barrier 40. Consequently, since the guardrails are mounted from the level below, no worker has to enter a level without guardrails when erecting a scaffolding structure 100. Similarly, when the scaffolding structure 100 is to be disassembled, the guardrails can be dismounted from the level below such that no person has to work or keep him- or herself on a level without guardrails. The guardrails 101, 102, 104, 105 of the scaffolding structure 100 may be fastened at each end to the vertical posts 106, 107 by conventional quick couplings well-known in the art. The horizontal longitudinal and lateral rails 109, 110 forming the support structure for the not yet mounted next level working deck is also shown in FIGS. 3a and 3b. The platform unit 1 may have a vertical height sufficient to also enjoy support against forward tipping by the horizontal longitudinal rail 109, as shown in FIGS. 3a and 3b, but this is not an essential feature. By means of the rollers 5 and the first and second tipping prevention members 20, 30 the platform unit 1 is capable of relatively effortless longitudinal motion between a position adjacent a first vertical post 106 and a position adjacent a second vertical post 107 also while carrying a load, all with a low accident risk.

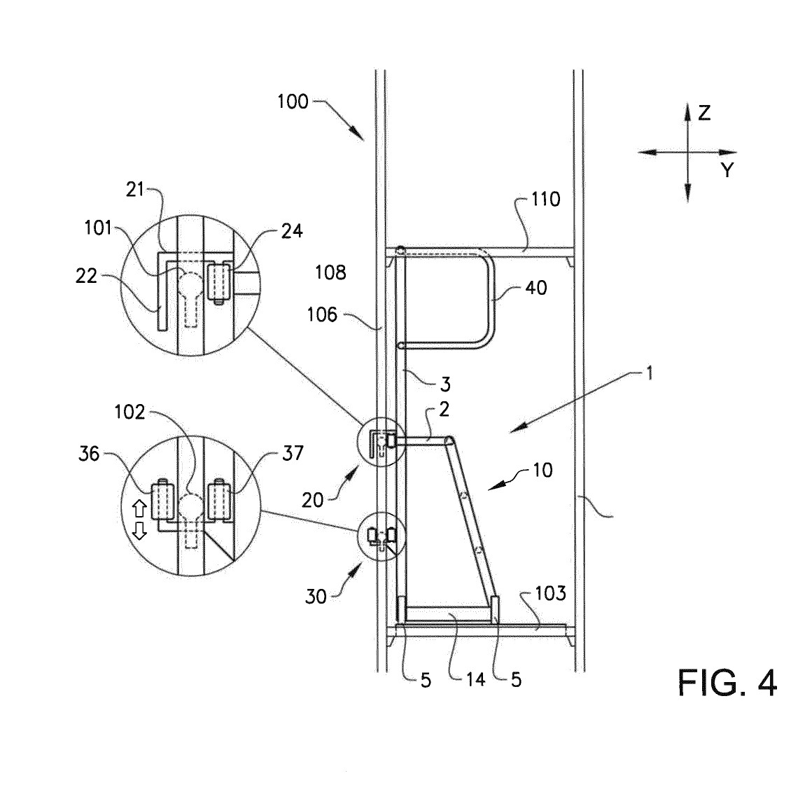

FIG. 4 shows the platform unit 1 according to a third embodiment secured to a scaffolding structure 100 similar to FIG. 2a-3b, but with an alternative design of the first and second tipping prevention members 20, 30. The second vertical part 23 of the first tipping prevention member 20 comprises a vertically oriented roller 24 whilst the first vertical part 22 and the horizontal part 21 of the first tipping prevention member 20 lacks any roller and are arranged to exhibit a sliding contact with the first rail 101 when necessary. The third and fourth vertical parts 32 33 of the second tipping prevention member 30 comprises vertically oriented rollers 36, 37, but the horizontal part 31 of the second tipping prevention member 30 lacks any roller and is arranged to exhibit a sliding contact with the second rail 102 when necessary.

Common for all described designs above is that the weight of the platform unit 1 and any load is carried only by the working deck 103 in a normal position of the platform unit. The tipping prevention members 20, 30 are only intended to prevent tipping and to horizontally guide the platform, not to carry any weight.

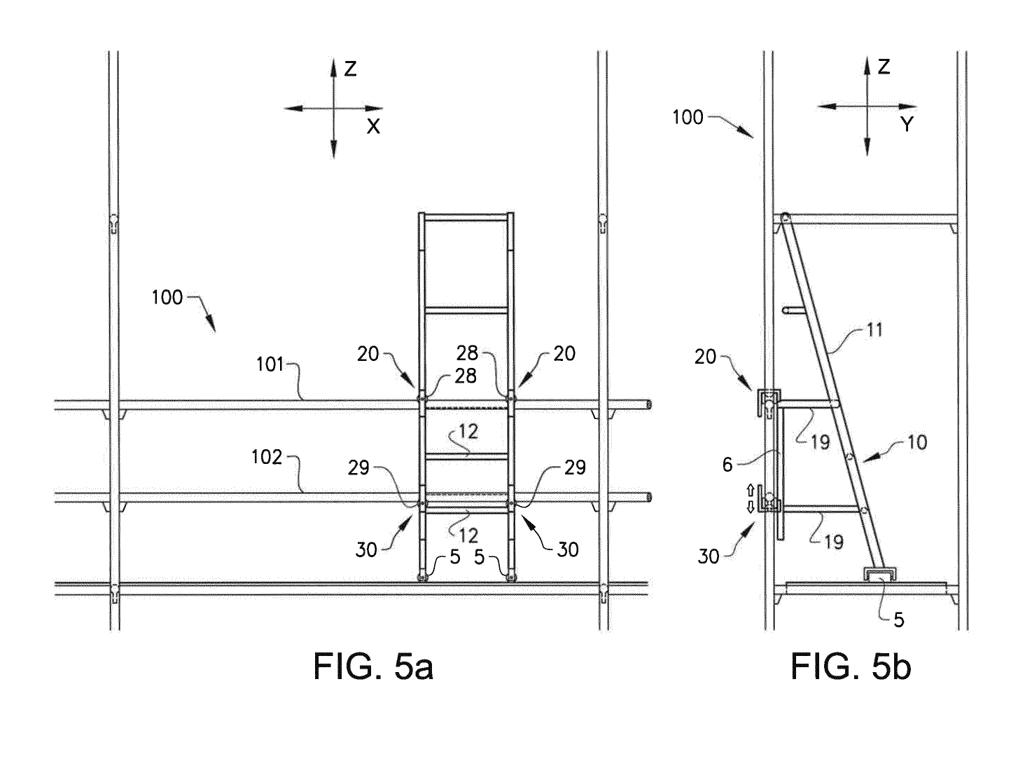

In FIG. 5 the platform unit 1 according to a fourth embodiment is illustrated secured to a scaffolding structure 100 from two different views: rear view (FIG. 5a) and side view (FIG. 5b). Here, the platform unit 1 contacts the working deck 103 only via a ladder 10 provided with two rollers 5 at the bottom of its side bars 11. The side bars 11 of the ladder extend above the worker's platform 2, but rungs 12 are only present below said worker's platform. The fall prevention barrier 40 is here formed by two cross-bars 40 extending between the side bars 11 at an upper portion of the platform unit 1. The cross-bars prevents that a user falls off the worker's platform 2 in a forward direction. The two first tipping prevention members are arranged to interact with a first support member 101 and the two second tipping prevention members 30 are arranged to interact with a second support member 102, where the first and second support members 101, 102 are constituted by vertically separated guardrails 101, 102 of the scaffolding structure 100. The tipping prevention members 20, 30 are mounted on two vertical bars 6, each vertical bar 6 being connected to the ladder side bars 11 via two horizontal members 19. The positions of the second tipping prevention members 30 are vertically adjustable in order to allow easy attachment to and detachment from the first and second rails 101, 102. At least the two first tipping prevention members 20 abut against the first rail 101 and part of the weight of the platform unit 1 and its load is carried by the first rail 101. In order for the movement of the platform unit 1 along the first rail 101 not to be hindered by friction between the first tipping prevention members 20 and the rails 101, 102, each first tipping prevention member 20 is internally provided with a roller 28 that rolls against the first rail 101 in directions along said rail 101. Each of the second tipping prevention members 30 is also illustrated comprising a roller 29. However, the second tipping prevention members 30 may alternatively exhibit rollerless third and fourth parts 32, 33 and horizontal parts 31 because these parts are only necessary during tipping conditions, such that the increased contact friction compared with a rolling contact is only temporarily noticeable. The rollers 28, 29 are preferably horizontally oriented and provided with a peripheral groove that is formed and dimensioned to properly interact with the exterior surface of the first and second rail 101, 102 respectively.

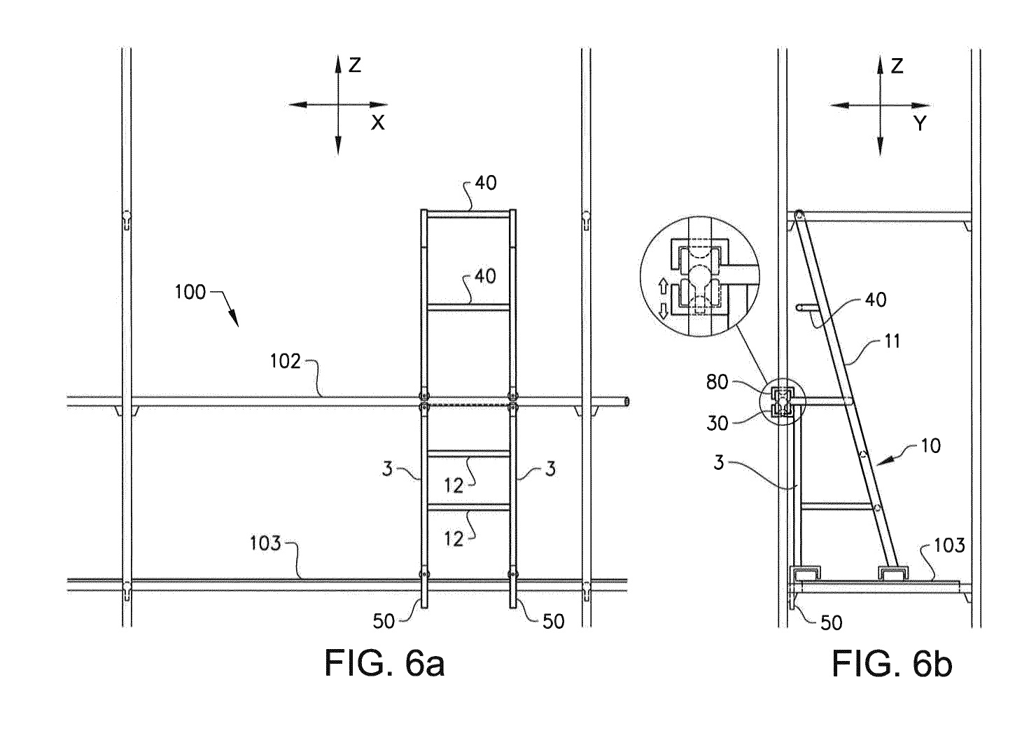

FIG. 6 shows the platform unit 1 according to a fifth embodiment secured to a scaffolding structure 100 from two different views: front view (FIG. 6a) and side view (FIG. 6b). The platform unit 1 comprises a first tipping prevention member 50 in form of a stopping member 50. The stopping member 50 is arranged to interact with a first support member 103 in form of a side of the working deck 103 or similar longitudinal extending member located adjacent to the working deck 103. In the shown example a single stopping member 50 is arranged at the bottom end of each leg 3 of the platform unit 1. The second tipping prevention member 30 has a similar design as the previously disclosed second tipping prevention members, i.e. a hook-shaped tipping prevention member 30 that engages a second support member 102. The second support member 102 is here formed by a rail 102. The rail 102 may be the single guard rail available on current segment of the scaffolding structure. The rail 102 may for example be located at approximately the same height as the worker's platform 2. The second tipping prevention member 30 is vertically adjustable for enabling attachment and detachment of the platform unit 1. A third tipping prevention member 80 is also shown interacting with the rail 102. The problem of forward tipping over the second rail 102 is solved by the first and second tipping prevention members 50, 30, wherein counter-clockwise (as seen in FIG. 6b) pivoting is prevented by engagement between the stopping members 50 and an outer edge of the working deck 103.

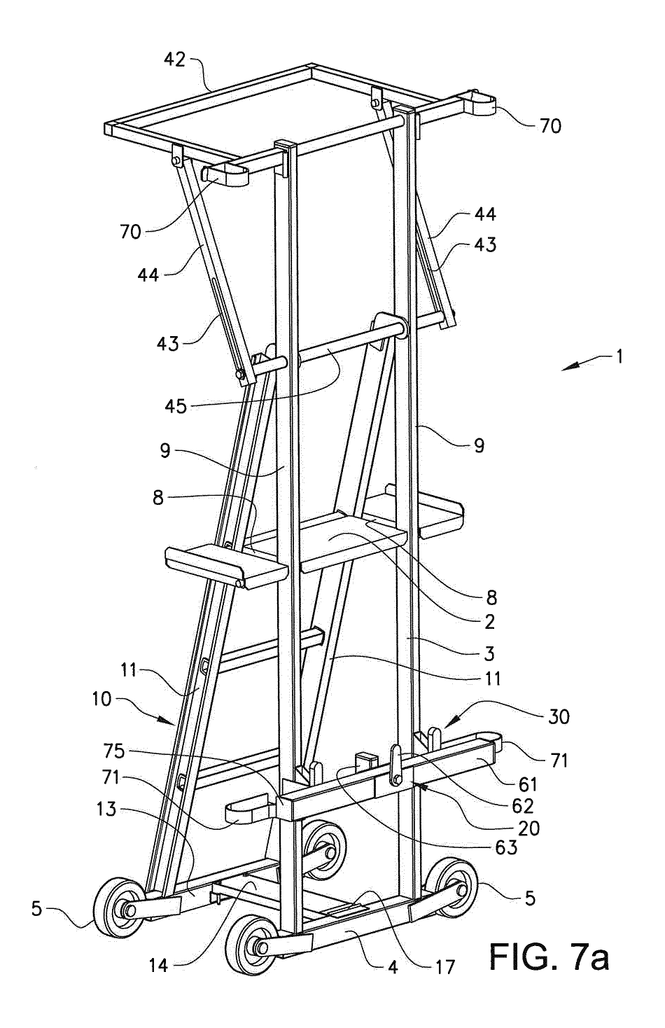

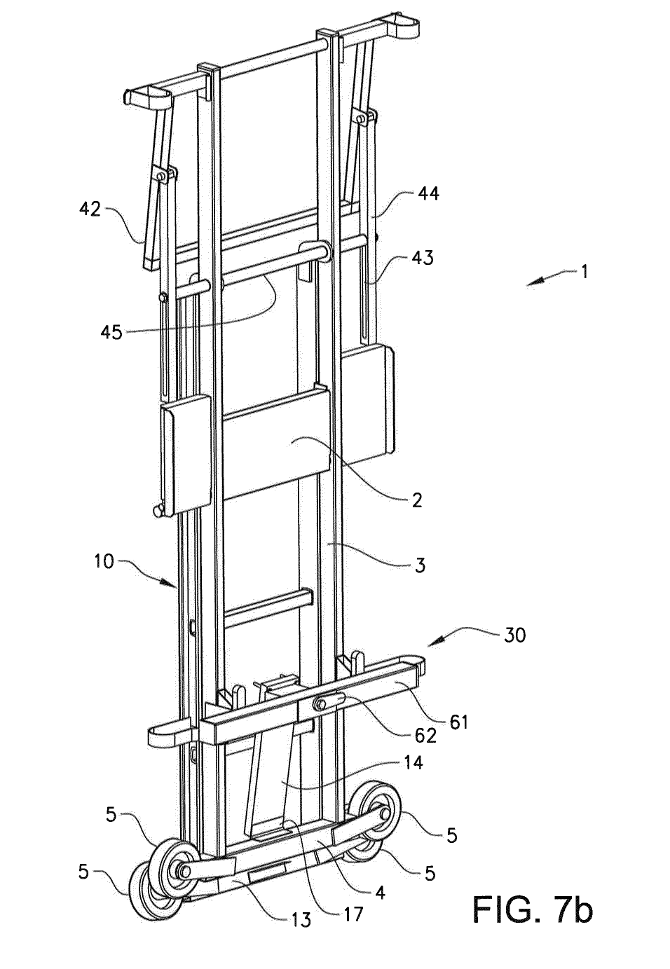

FIG. 7a shows the platform unit 1 according to a sixth embodiment with still a modified design. The worker's platform 2 is supported by two legs 3 and a ladder 10. The ladder is pivotably attached to a horizontal bar 45 which in turn is mounted to the upper part of the legs 3. As used herein, the term upper leg part refers to a portion of the leg 3 that is situated above the worker's platform 2. The platform unit 1 is adapted to contact the ground or a working deck via four rollers 5, one adjacent to the bottom end of each leg 3 and each ladder side bar 11. The bottom ends of the legs 3 are connected by a first horizontal member 4 and the ladder side bars 11 are connected by a second horizontal member 13, said horizontal members 4, 13 being connected by a reinforcing member 14 for stability. The reinforcing member 14 is attached to the first horizontal member 4 via a hinge 17, and removably attached to the second horizontal member 13 to provide foldability to the platform unit 1. The worker's platform 2 extends beyond the legs 3 in the longitudinal direction X. This is enables by providing the worker's platform with two slots 8 arranged to receive the ladder side bars 10 and legs 3 in order to allow the ladder 10 to be folded towards the legs 3. The legs 3 extend above the worker's platform 2 and are provided with a four-sided fall prevention barrier 40 supported by two side rods 44 hingedly connected to the fall prevention barrier 40 at their upper ends and connected to the horizontal bar 45 via a side bar slot 43 in their lower portion in order to allow the fall prevention barrier 40 to be folded down towards the legs 3. In this design of the platform unit 1, the first tipping prevention member 3 is constituted by a portion of each leg 3. The portion of each leg 3 is arranged to interact with a first rail 101 of a scaffolding structure simply by abutment. The second tipping prevention member 30 comprises a substantially horizontal base member 61 and a rotatable locking element 62 which is operated by turning a locking element operating member 63. In order to secure this design of the platform unit 1, the locking element 62 is put in a substantially horizontal state (shown in FIG. 7b) in which it does not protrude above the base member 61. The platform unit 1 is then moved towards the rails 101, 102 of the scaffolding structure such that the base member 61 of the second tipping prevention member 30 is positioned under and substantially aligned with the second rail 102. The locking element operating member 63 is then turned in order to rotate the locking element 62 to adjust its vertical position to a substantially vertical position in which is extends above the base member 61. This results in that the second rail 102 being captured in the space defined by the legs 3, the base member 61, and the locking element 62, such that the platform unit 1 becomes attached to the scaffolding structure. In this design, the locking element 62 is rotatable, but other types of movability of the locking element are also possible, for example linear or curved motion in a vertical plane. Two or more locking elements 62 are also possible, controlled by a single or individual locking element operating members 63.

The platform unit 1 is further provided with upper and lower material holders 70, 71. For example rails that are intended to build on to the scaffolding structure can be held in these material holders. Preferably, a rail is held vertically by one upper material holder 70 and a lower material holder 71 such that the platform unit 1 can move in a longitudinal direction, bringing the rail along. Equipped with material holders, a couple of rails can be transported along with the platform unit, without tiring the scaffolders or occupying their hands.

Furthermore, the platform unit 1 of FIG. 7a is provided with two end stop surfaces 75, one at each horizontal end of the base member 61 of the second tipping prevention member 30. The end stop surfaces 75 make sure that the longitudinal motion of the platform unit 1 stops properly when the platform unit 1 encounters a vertical post of the scaffolding structure.

FIG. 7b shows the platform unit of FIG. 7a in a folded configuration. Here, the reinforcement member 14 has been detached from the second horizontal member 13 and folded at the hinge 17 into a position substantially parallel with the legs 3. With the reinforcement member 14 no longer attached to the second horizontal member 13, the ladder 10 is pivotable around the horizontal bar 45 and has been folded to a position adjacent and parallel to the legs 3. The fall prevention barrier 40 has been folded downwards to a position almost parallel to the legs 3. In this substantially parallel, slim configuration, the platform unit 1 is easy to transport and store.

The invention also concerns a method for attaching a platform unit 1 as described above to a scaffolding structure 100. During assembly of a scaffolding structure 100 the platform unit 1 is transported to the uppermost working level having at least one support member 101, 102, such as a guardrail 101, 102, installed. The platform unit 1 is then positioned such that the first and second tipping prevention members 20, 30, 50, 3 are located close to the first and second support member 101, 103, 102 respectively. This means that the first tipping prevention member 20, 50, 3 is located above the first rail 101 or outside of the working deck 103, and that the second tipping prevention member 30 is located below the second rail 102, depending on the specific design of the platform unit 1. As a final step, at least a part 62 of at least one of the first and second tipping prevention members 20, 50, 3, 30 is adjusted in a vertical direction, such that the platform unit 1 becomes attached to the scaffolding structure 100. Due to the joint arrangement of the first and second tipping prevention members 20, 50, 3, 30 to enable prevention of the platform unit 1 from tipping in the longitudinal direction and a lateral direction, the first and second tipping prevention members 20, 50, 3, 30 cannot be properly mounted to the scaffolding structure 100 without at least one of the tipping prevention members 20, 50, 3, 30 is adjusted to securely attach the platform unit to the scaffolding structure 100.

Reference signs mentioned in the claims should not be seen as limiting the extent of the matter protected by the claims, and their sole function is to make claims easier to understand. As will be realised, the invention is capable of modification in various obvious respects, all without departing from the scope of the appended claims. For example, the first and second tipping prevention members 20, 30 may lack any rollers, have one or more vertically oriented rollers and/or one or more horizontally oriented rollers. The platform unit preferably comprises two longitudinally spaced first tipping prevention members 20 and two oppositely arranged longitudinally spaced apart second tipping prevention members 30, but a single first and/or second tipping prevention member 20, 30 may alternatively be used, where this single first and/or second tipping prevention member 20, 30 preferably has a longitudinal length of at least about 30 millimetres, more preferably at least about 50 millimetres, and still more preferably at least about 75 millimetres for improved distribution of contact forces during longitudinal tipping of the platform unit. The first tipping prevention member 20 may be located above the second tipping prevention member 20, or oppositely. The ladder 10 may comprise a single rung 12, depending on the height of the worker's platform 2, but a about two or three rungs 12 are preferred considering the standard dimensions of scaffolding structures 100. The ladder may extend inclined compared with a vertical direction and the longitudinal extension of the legs 3 for simplified climbing thereof. The ladder 10 may however be less inclined or even completely vertical for space saving. The ladder 10 may have a smaller longitudinal extension than the worker's platform 2, or substantially the same longitudinal extension than the worker's platform 2. The first horizontal member 4 may exhibit a larger longitudinal extension than the second horizontal member 13, or the same, and one or both of the first and second horizontal members 4, 13 may have a larger longitudinal extension than the worker's platform 2 for improved longitudinal stability. The platform unit 1 according to the shown designs herein is not foldable but a foldable platform unit is consistent with the invention. For example, the platform unit design of FIG. 1b may be provided with a folding function where the reinforcing members 14 can pivot around the first horizontal member 4 and the worker's platform 2 can pivot around its fastening points to the legs 3, thereby providing a more compact and transportable platform unit 10. The worker's platform 2 may comprise a plurality of longitudinally oriented bars 7 as shown in FIG. 1c, or alternatively be formed of a plate. All shown embodiments of the platform unit 1 have been illustrated and described using either two rails, or one rail and the working deck, as support members. The invention is however not limited to rails and/or working deck as support members and many alternative support members may be used, depending on the specific design of the scaffolding structure. Also, only the second tipping prevention members 30 have been disclosed being vertically adjustable while the first tipping prevention members 20, 50, 3 have been disclosed being stationary. This invention is however not limited to this specifically shown embodiments and non-showed embodiments having vertically adjustable first tipping prevention members are equally applicable. Individual design features from the different designs herein may be combined with each other to form non-shown combinations of the invention. Accordingly, the drawings and the description thereto are to be regarded as illustrative in nature, and not restrictive.

1. A platform unit for use with a scaffolding structure, the platform unit comprising:
a worker's platform, and
a ladder for climbing onto the worker's platform, wherein the platform unit further comprises:
a first tipping prevention member which is adapted to interact with a substantially horizontal longitudinally extending first support member of the scaffolding structure,
a second tipping prevention member which is adapted to interact from below with a substantially horizontal longitudinally extending second support member, which second support member is vertically spaced apart from the first support member, wherein at least a part of at least one of the first and second tipping prevention members is vertically adjustable for enabling attachment and detachment of the platform unit to said scaffolding structure, and
at least three rollers for supporting the platform unit, wherein each of the rollers is adapted to rest against either said first support member or said second support member, such that the platform unit is rollingly movable in the longitudinal direction.

2. The platform unit according to claim 1, wherein:
the platform unit is a free-standing unit,
each of said at least three rollers is adapted to rest against the working deck and to transfer any vertical load acting on the worker's platform to the working deck when the platform unit is in a normal position, and
the first and second tipping prevention members are arranged to guide the platform unit along the first and second support members.

3. The platform unit according to claim 2, wherein the platform unit comprises at least four rollers that are adapted to rest against the working deck.

4. The platform unit according to claim 1, wherein at least one of the at least three rollers is provided at the first tipping prevention member, and the roller is arranged to transfer a load to the first support member when the platform unit is in an attached position.

5. The platform unit according to claim 1, wherein at least one of the at least three rollers is provided at or adjacent to the bottom end of the ladder and arranged to rest on the working deck.

6. The platform unit according to claim 1, wherein a pair of legs extend generally vertically downwards from a front end of the worker's platform, and at least one of the at least three rollers is provided at or adjacent to the bottom end of each leg, which the at least one of the at least three rollers is adapted to contact the working deck.

7. The platform unit according to claim 1, wherein the second tipping prevention member comprises at least one roller which is arranged to transfer a load to the second support structure when the platform unit is in an attached position, and wherein the platform unit is free from any contact to the working deck.

8. The platform unit according to claim 1, wherein the first tipping prevention member is hook-shaped and exhibits a cavity open from below, which cavity is arranged to receive the first support member, such that the first tipping prevention member can transmit a vertical and/or horizontal force to the first support member.

9. The platform unit according to claim 1, wherein the first tipping prevention member is constituted by a rigid stopping member extending downwards and arranged to interact with a side surface of the working deck or scaffolding structure for preventing the platform unit from tipping forwards.

10. The platform unit according to claim 6, wherein the pair of legs also extend upwards from the worker's platform.

11. The platform unit according to claim 6, wherein a leg portion of at least one of the pair of legs constitutes the first tipping prevention member.

12. The platform unit according to claim 1, wherein the second tipping prevention member is hook-shaped and exhibits a cavity open from above, which cavity is arranged to receive the second support member, such that the second tipping prevention member can transmit a vertical and/or a horizontal force to the second support member.

13. The platform unit according to claim 1, wherein the first and/or second tipping prevention member comprises at least one substantially vertically oriented roller, which is arranged to transfer the horizontal force to the first or second support member.

14. The platform unit according to claim 1, wherein the first and/or second tipping prevention member comprises at least one substantially horizontally oriented roller, which is arranged to transfer the horizontal force to the first or second support member.

15. The platform unit according to claim 14, wherein the at least one substantially horizontally oriented roller exhibits a peripheral groove that is arranged to interact with the first or second support member, such that the roller may transfer both vertical and horizontal forces to the first or second support member.

16. The platform unit according to claim 1, wherein at least one of the first and second tipping prevention members comprises a rotatable locking element that may be manually rotated for adjusting the vertical position of the locking element.

17. The platform unit according to claim 16, wherein the rotatable locking element may be manually rotated by turning an operating member.

18. The platform unit according to claim 16, wherein the rotatable locking element is attached to a substantially horizontally extending base member that is arranged to be located below the second support member in the attached position.

19. The platform unit according to claim 1, wherein at least one of the first and second tipping prevention members is vertically slidable for adjusting the vertical position of the at least one of the first and second tipping prevention members.

20. A platform unit according to claim 1, wherein the platform unit comprises two first tipping prevention members spaced apart in the longitudinal direction.

21. The platform unit according to claim 1, wherein the platform unit comprising a fall prevention barrier that is arranged to prevent a user positioned on the worker's platform from falling off the platform unit.

22. The platform unit according to claim 1, wherein the platform unit comprises at least one scaffolding material holder.

23. The platform unit according to claim 1, wherein the platform unit comprises at least one end stop surface adapted to stop a longitudinal motion of the platform unit upon encounter with a vertical post of the scaffolding structure.

24. The platform unit according to claim 1, wherein the platform unit is foldable into a substantially parallel folded configuration.

25. The platform unit according to claim 1, wherein the substantially horizontal longitudinally extending first support member is a first rail or a working deck.

26. The platform unit according to claim 1, wherein the substantially horizontal longitudinally extending second support member is a second rail.

27. The platform unit according to claim 1, wherein only one of the first and second tipping prevention members is vertically adjustable.

28. The platform unit according to claim 6, wherein the ladder is pivotally attached to the pair of legs for enabling folding of the platform unit.

29. The platform unit according to claim 6, wherein the worker's platform is pivotally attached to the pair of legs for enabling folding of the platform unit.

30. The platform unit according to claim 6, wherein the fall prevention barrier is pivotally attached to the pair of legs for enabling folding of the platform unit.

31. A scaffolding structure comprising a substantially horizontal longitudinally extending first support member, wherein the scaffolding structure further comprises a platform unit according to claim 1, wherein the platform unit is secured to the scaffolding structure by means of the first and second tipping prevention members.

32. A method for attaching a platform unit according to claim 1 to a scaffolding structure comprising:
positioning the platform unit such that the first and second tipping prevention members are located close to the first and second support member respectively; and
adjusting at least a part of at least one of the first and second tipping prevention members in a vertical direction, such that the platform unit becomes attached to said scaffolding structure.
